(19) United States
(12) Patent Application Publication
(10) Pub. No.: US 2006/0178287 A1
(43) Pub. Date: Aug. 10, 2006

(54) Detergent particles

(75) Inventor: Hossam Hassan Tantawy, Northumberland (GB)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/348,153

(22) Filed: Feb. 6, 2006

(30) Foreign Application Priority Data
Feb. 7, 2005 (EP) 05250669.8

(51) Int. Cl. C11D 17/00

(52) U.S. Cl. 510/446

(57) ABSTRACT

The present invention relates to detergent composition comprising at least two granular components: (1) a first granule comprising high levels of a polycarboxylate-polymer and phosphate salt and at least 8 wt % surfactant and optional additional detergent ingredients; and (2) a second granule comprising at least 75 wt % (based on the second granule) of a phosphate salt and optional additional. In a preferred aspect of the invention, the first granule is a spray-dried particle.

### TECHNICAL FIELD

The present invention relates to the field of phosphate-built laundry detergent compositions having medium to high bulk density.

### BACKGROUND OF THE INVENTION AND PRIOR ART

High bulk density granular detergent compositions are well known and have been manufactured for many years. They have the advantages over low bulk density detergent compositions of providing more active cleaning components per unit volume and requiring less volume for storage.

Detergent builders included in such detergents can be selected from a wide range of materials. However, the most usual as a main builder are salts of carbonates, phosphates and/or aluminosilicates such as zeolites. Sodium phosphates are known as particularly good builders as they have particularly good calcium binding capacity.

A phosphate-built detergent composition is described in WO98/54287 in which poor powder properties of phosphate and surfactant-containing particles is overcome by formulating the detergent with a proportion of the surfactant formulated as particles containing a high proportion of surfactant. This reference also states that it is known in the art to include a relatively high proportion of material, typically builder material, which has a better carrying capacity than sodium tripolyphosphate to enable high surfactant concentrations to be achieved.

In the present invention, a high bulk density detergent composition having tripolyphosphate as the predominant builder material and having acceptable or good powder properties is achieved by formulating a component comprising phosphate builder with high levels of polymeric material.

### DEFINITION OF THE INVENTION

In accordance with the present invention there is provided a detergent composition comprising at least two granular components: (1) a first granule comprising at least 6 wt % (based on the first granule) of a polycarboxylate-polymer or mixtures thereof, at least 25 wt % phosphate salt and at least 8 wt % surfactant and optional additional detergent ingredients; and a (2) a second granule comprising at least 75 wt % (based on the second granule) of a phosphate salt and optional additional detergent ingredients.

The detergent compositions of the invention preferably comprises from 20 to 75 wt %, more preferably from 35 to 60 wt % of the first granule, and from 3 to 20 wt %, preferably from 5 to 12% or even 10% by weight of the second granule, based on the weight of the fully formulated detergent composition.

It has been found that detergent compositions formulated in this way have good flow properties, with low stickiness, good particle physical robustness and good capacity for absorbing surfactant or other liquid components for incorporation into the detergent. One additional benefit is that detergent compositions of high bulk density can be achieved even from a traditionally low bulk density spray-drying process.

The detergent compositions of the present invention preferably have a high bulk density, preferably greater than 600 g/l, particularly preferably greater than 700 g/l.

### DETAILED DESCRIPTION OF THE INVENTION

Surfactant

The detergent compositions of the invention comprise one or more detergent active compounds (surfactants) which may comprise anionic, cationic, non-ionic, amphoteric or zwitterionic surfactants or mixtures thereof. The detergent compositions of the invention preferably comprise at least 10 wt % up to 50 wt %, more preferably at least 15 wt % or even at least 25 wt %, or even at least 30 wt % based on the fully formulated detergent composition.

Preferred anionic surfactants comprise one or more moieties selected from the group consisting of carbonate, phosphate, sulphate, sulphonate and mixtures thereof. Preferred anionic surfactants are C₈₋₁₈ alkyl sulphates and C₈₋₁₈ alkyl sulphonates. Suitable anionic surfactants incorporated alone or in mixtures in the compositions of the invention are also the C₈₋₁₈ alkyl sulphates and/or C₈₋₁₈ alkyl sulphonates optionally condensed with from 1 to 9 moles of C₁₋₄ alkylene oxide per mole of C₈₋₁₈ alkyl sulphate and/or C₈₋₁₈ alkyl sulphonate. The alkyl chain of the C₈₋₁₈ alkyl sulphates and/or C₈₋₁₈ alkyl sulphonates may be linear or branched, preferred branched alkyl chains comprise one or more branched moieties that are C₁₋₆ alkyl groups. Other preferred anionic surfactants are C₈₋₁₈ alkyl benzene sulphates and/or C₈₋₁₈ alkyl benzene sulphonates. The alkyl chain of the C₈₋₁₈ alkyl benzene sulphates and/or C₈₋₁₈ alkyl benzene sulphonates may be linear or branched, preferred branched alkyl chains comprise one or more branched moieties that are C₁₋₆ alkyl groups.

Other preferred anionic surfactants are selected from the group consisting of: C₈₋₁₈ alkenyl sulphates, C₈₋₁₈ alkenyl sulphonates, C₈₋₁₈ alkenyl benzene sulphates, C₈₋₁₈ alkenyl benzene sulphonates, C₈₋₁₈ alkyl di-methyl benzene sulphate, C₈₋₁₈ alkyl di-methyl benzene sulphonate, fatty acid ester sulphonates, di-alkyl sulphosuccinates, and combinations thereof. The anionic surfactants may be present in the salt form. For example, the anionic surfactant may be an alkali metal salt of one or more of the compounds selected from the group consisting of: C₈₋₁₈ alkyl sulphate, C₈₋₁₈ alkyl sulphonate, C₈₋₁₈ alkyl benzene sulphate, C₈-C₁₈ alkyl benzene sulphonate, and combinations thereof. Preferred alkali metals are sodium, potassium and mixtures thereof. Typically, the detergent composition comprises from 10% to 30 wt % anionic surfactant.

Preferred non-ionic surfactants are selected from the group consisting of: C₈₋₁₈ alcohols condensed with from 1 to 9 of C₁-C₄ alkylene oxide per mole of C₈₋₁₈ alcohol, C₈₋₁₈ alkyl N—C₁₋₄ alkyl glucamides, C₈₋₁₈ amido C₁₋₄ dimethyl amines, C₈₋₁₈ alkyl polyglycosides, glycerol monoethers, polyhydroxyamides, and combinations thereof. Typically the detergent compositions of the invention comprises from 0 to 15, preferably from 2 to 10 wt % non-ionic surfactant.

Preferred cationic surfactants are quaternary ammonium compounds. Preferred quaternary ammonium compounds comprise a mixture of long and short hydrocarbon chains, typically alkyl and/or hydroxyalkyl and/or alkoxylated alkyl chains. Typically, long hydrocarbon chains are C₈₋₁₈ alkyl chains and/or C₈₋₁₈ hydroxyalkyl chains and/or C₈₋₁₈ alkoxylated alkyl chains. Typically, short hydrocarbon chains are C₁₋₄ alky chains and/or C₁₋₄ hydroxyalkyl chains and/or C₁₋₄ alkoxylated alkyl chains. Typically, the detergent composition comprises (by weight of the composition) from 0% to 20% cationic surfactant.

Preferred zwitterionic surfactants comprise one or more quaternized nitrogen atoms and one or more moieties selected from the group consisting of: carbonate, phosphate, sulphate, sulphonate, and combinations thereof. Preferred zwitterionic surfactants are alkyl betaines. Other preferred zwitterionic surfactants are alkyl amine oxides. Catanionic surfactants which are complexes comprising a cationic surfactant and an anionic surfactant may also be included. Typically, the molar ratio of the cationic surfactant to anionic surfactant in the complex is greater than 1:1, so that the complex has a net positive charge.

The detergent compositions of the invention comprise polycarboxylate polymer. The polycarboxylate polymers include homopolymers or copolymers. Suitable polymers include homopolymers or copolymers of dicarboxylic acids such as maleic acid, itaconic acid, mesaconic acid, fumaric acid, citraconic acid and the derivatives of such acids including anhydrides of dicarboxylic acids, such as maleic anhydride; monocarboxylic acids such as acrylic acid, methacrylic acid, vinyl acetic acid, crotonic acid and acryloxypropionic acid.

Polymers can be in acid or neutralized or partially neutralized form with Na, K, or other counterions. Preferred polycarboxylate polymers are homopolymers of acrylic acid and copolymers of acrylic and maleic acids. Especially preferred are the acrylic/maleic copolymers available from BASF as Sokalan (tradename) CP5 and CP7 (salt form) and CP45 (acid form).

The average molar mass Mw of the polymers is typically from 500 to 5,000,000. Preferably the molecular weight will be above 10 000, more preferably above 20 000. The molecular weight may be below 1 000 000, but is usually below 500 000 or even 100 000.

Preferably the polymer will have a Brookfield viscosity (measured on a Brookfield LVT with a 20% solution of active substance in distilled water at 23° C., spindle 1 at 60 rpm) of from 25 to 60, preferably 30 to 50.

The phosphate builder may be any phosphate builder salt, but is preferably a tripolyphosphate salt. The most counter ions for the phosphate salts are sodium and potassium with sodium being most preferred. Preferably the phosphate builder salt is sodium tripolyphosphate.

One other significant benefit of the present invention is that the detergent compositions of the invention can be formulated with relatively low levels of inorganic filler materials such as sodium sulfate, whilst still achieving acceptable particle properties. Preferably, the detergent compositions of the invention comprise less than 10 wt % (based on the fully formulated detergent composition) sodium sulfate, or even below 5 or even 2 wt % sodium sulfate. Also, the detergent compositions of the invention may comprise below 10 wt % sodium carbonate, or even below 5 wt % (based on the fully formulated detergent composition).

First Granule

The first granule comprises at least 6 wt % (based on the first granule) of a polycarboxylate-polymer or mixtures thereof, at least 20 wt % phosphate salt and at least 10 wt % surfactant.

The polycarboxylate polymer is as described above. Preferably the first granule comprises greater than 8 wt % or even greater than 10 or greater than 12 wt % based on the weight of the first granule. The amount of polycarboxylate polymer in the first granule will generally be no more than 30 wt %, preferably no more than 20 wt % of the granule. The quantities of polymer defined in this patent application are based on the equivalent fully neutralised sodium salt form of the polymer; for acid forms of polymer or other salt form, the amount used should be adjusted accordingly to be within the ranges defined.

The phosphate salt is as described above, preferably being sodium tripolyphosphate. This is generally present in the first granule in amounts from 20 to 70 wt % of the granule or even from 25 to 65 wt %.

The surfactant in the first granule is any surfactant described above, but is generally selected from anionic and/or non-ionic and/or cationic surfactants or mixtures thereof. Preferably, the surfactant comprises anionic surfactant, either wholly or partially. Particularly preferred anionic surfactants are alkylbenzene sulphonate surfactants as described above, often referred to as LAS. The surfactant amount in the first granule is at least 8 wt % based on the granule, or even at least 12 or at least 15 wt % and may be up to, for example 40 or 50 or even up to 60 wt %, based on the weight of the granule. Preferably the level of sodium sulphate in the first granule is below 5 wt % or even below 2 wt % or even below 1 or 0.5 wt % based on the weight of the granule. Preferable the level of sodium carbonate is below 10 wt %, more preferably below 5 wt % or even below 2 wt % or 1 wt % based on the weight of the granule.

The first granule is made by agglomeration, extrusion or spray-drying, preferably by a spray-drying process. Any conventional agglomeration or extrusion process may be used. In the preferred spray-drying process, the polymer, phosphate, surfactant and any optional additional ingredients are mixed with water to form a slurry which is then spray-dried by conventional means (usually using warm air drying although spray cooling may also be useful). Generally this will be in a spray-drying tower using a high pressure (e.g. 6000-7000 kPa) spray nozzle. Spinning disc atomisers may also be used. Generally raw materials which are provided by suppliers in solution or dispersion in water are pre-mixed and the solids including phosphate are subsequently added.

Optional additional ingredients can be incorporated in the first granule. One preferred component for addition to the slurry is a cationic amine component, particularly for example alkoxylated cationic diamines, polyamines or polymers of mixtures thereof, particularly as described in EP-A-111965. It has been found that such components not only provide a clay soil removal/anti-redeposition benefit in the final cleaning composition but also help in the processing of the slurry and in providing well-structured particles. Particularly preferred cationic amine components are optionally sulphated or sulphonated and selected from the group consisting of:

1) ethoxylated cationic monoamines having the formula:

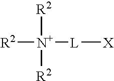

2) ethoxylated cationic diamines having the formula: 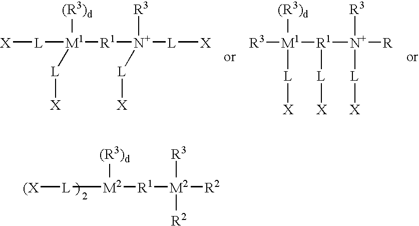
wherein M¹ is an N+ or N group; each M² is an N+ or N group, and at least one M² is and N+ group;

3) ethoxylated cationic polyamines having the formula:

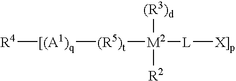

4) mixtures thereof;
wherein A¹ is 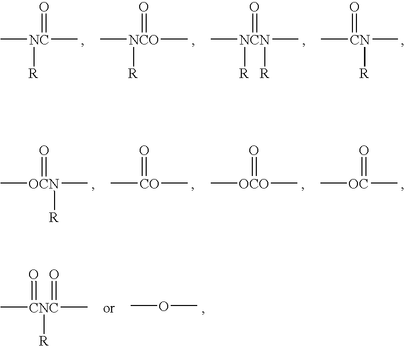
R is H or C₁-C₄ alkyl or hydroxyalkyl, R¹ is C₂-C₁₂ alkylene, hydroxyalkylene, alkenylene, arylene or alkarylene, or a C₂-C₃ oxyalkylene moiety having from 2 to about 20 oxyalkylene units provided that no O—N bonds are formed; each R² is C₁-C₄ alkyl or hydroxyalkyl, the moiety -L-X, or two R² together form the moiety —(CH₂)ᵣ-A²-(CH₂)ₛ—, wherein A² is —O— or —CH₂—, r is 1 or 2, s is 1 or 2 and r+s is 3 or 4; each R³ C₁-C₈ alkyl or hydroxyalkyl, benzyl, the moiety L-X, or two R³ or one R² and one R³ together form the moiety —(CH₂)ᵣ-A²-(CH₂)ₛ—; R⁴ is a substituted C₃-C₁₂ alkyl, hydroxyalkyl, alkenyl, aryl or alkaryl group having p substitution sites; R⁵ is C₁-C₁₂ alkenyl, hydroxyalkylene, alkenylene, arylene or alkarylene, or a C₂-C₃ oxyalkylene moiety having from 2 to about 20 oxyalkylene units provided that no O—O or O—N bonds are formed; X is a non-ionic group selected from the group consisting of H, C₁-C₄ alkyl or hydroxyalkyl ester or ether groups, and mixtures thereof; L is a hydrophilic chain which contains the polyoxyalkylene moiety —[(R⁶O)ₘ(CH₂CH₂O)ₙ]—; wherein R⁶ is C₃-C₄ alkylene or hydroxyalkylene and m and n are numbers such that the moiety —(CH₂CH₂O)ₙ-comprises at least about 50% by weight of said polyoxyalkylene moiety; d is 1 when M² is N+ and is 0 when M² is N; n is at least about 16 for said cationic monoamines, is at lest about 6 for said cationic diamines and is at least about 3 for said cationic polyamines; p is from 3 to 8; q is 1 or 0; t is 1 or 0, provided that t is 1 when q is 1. Diamines are preferred, especially diamines represented by the formula: bis((C₂H₅O)(C₂H₄O)ₙ)(CH₃)—N⁺—CₓH₂ₓ—N⁺—(CH₃)-bis((C₂H₄O)ₙ(C₂H₅O)), wherein, n=from 10 to 50 and x=from 1 to 20.

In a further embodiment of the invention, chelants or mixtures of chelants are present in the particles of the invention, generally at levels of from 0 to 45 wt %, preferably at levels from 1 to 20 wt % or even 2 to 15 wt %. Suitable chelants can be selected from the group consisting of carboxylates, phosphonates, polyfunctionally-substituted aromatic chelants and mixtures thereof. The chelant is preferably a phosphonic acid or succinic acid, or salt thereof.

Useful carboxylates include ethylenediaminetetracetates (“EDTA”), N-hydroxyethylethylene diaminetriacetates, nitrilotriacetates, ethylene diamine tetraproprionates, triethylene tetraaminehexacetates, diethylenetriaminepentaacetates, and ethanoldiglycines, alkali metal, ammonium, and substituted ammonium salts thereof, and mixtures thereof.

Useful phosphonates include ethylenediaminetetrakis (methylenephosponates), sold as DEQUEST®. Preferably these amino phosphonates do not contain alkyl or alkenyl groups with more than about 6 carbon atoms. Particularly preferred chelants are diethylene triamine penta (methylene phosphonic acid) (“DTPMP”) and ethylene diamine tetra (methylene phosphonic acid) (EDTMP) and hydroxyethylenediphosphonate (HEDP).

Polyfunctionally-substituted aromatic chelants are also useful in the components herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelant for use herein is ethylene diamine-N,N-disuccinate (“EDDS”), especially the [S,S] isomer as described in U.S. Pat. No. 4,704,233, issued on Nov. 3, 1987, to Hartman and Perkins.

Magnesium salts, particularly magnesium sulphate, have been found to be useful in ensuring efficient processing in first granules made by the preferred spray drying process. In particular when chelant is present, preferably a magnesium salt is also present. Generally the magnesium salt will be present at levels of from 0-40 wt % of the particle, preferably 0.1 to 10 wt %, more preferably from 0.5 to 5 wt %. Magnesium sulphate is particularly preferred. The chelating agent may be pre-complexed with a metal salt such as magnesium in order to provide some protection from degradation in the presence of bleach. Preferably this is done by dissolving a salt of the metal ion into a solution of the chelating agent in the required ratios. The molar ratio of metal ion to chelating agent is preferably at least 1:1, the present invention allows molar ratios of greater than 3:1 to be prepared, most preferred is a molar ratio of about 5:1. Again, whilst any metal salt may be used, magnesium sulphate is most preferred.

Sodium silicate may also be incorporated into the first granules, preferably in amounts from 0 up to 20 wt %, generally in amounts from 1 to 15 wt % or up to a maximum of 10 wt %.

In a further embodiment of the invention, the first granules additionally contain other ingredients which are incorporated in detergent compositions in minor amounts, such as at levels below 10 wt %, more usually below 5 wt %, or even below 2 wt % or even lower in the finished detergent product. Examples of such materials include polymers useful in detergent compositions such as soil release polymers, optical brighteners, dye-transfer inhibitors (such as PVP, PVNO, PVPVI and combinations thereof), anti-redeposition agents such as CMC, etc. In particular the present invention is useful for incorporating into a detergent composition components which are used at low levels in finished product and which are available from suppliers in an aqueous-based form such as a solution of suspension or dispersion in water. These materials can be added directly to the slurry for spray-drying.

The preferred average particule size of the first granule is from 300 to 650 microns or 350 to 600 microns. The preferred bulk density is from 200 to 500 g/l.

Second Granule

The second granule comprises at least 75 wt % based on the total weight of the second granule, of phosphate salt as described above. The preferred phosphate is sodium tripolyphosphate. Whilst this particle may be an agglomerate or spray-dried particle, incorporating additional detergent ingredients, preferably it is a particle of phosphate salt, preferably sodium tripolyphosphate, with no additional detergent ingredients. The preferred average particle size or the second granule is from 300 to 650 microns, or from 350 to 600. The bulk density of the second granule is preferably from 500 to 1200 g/l, or even 650 to 1000 g/l or from 700 up to 800 g/l.

In accordance with a further aspect of the invention, the detergent compositions of the invention comprise an additional, third granule comprising builder which may be phosphate, carbonate or zeolite builder in addition to a surfactant as described above, the surfactant being present in an amount preferably above 35 wt %, more preferably above 40 wt % or even above 45 wt %, generally being below 70 wt %, more typically being below 60 wt % or even 55 wt % based on the total weight of the third granule. Suitable third granules may be made by spray-drying or more typically by agglomeration or extrusion processes. Such a third granule may be incorporated into the detergent compositions of the invention in amounts from 0% by weight up to 40 wt %, more usually up to 20 or even 15 wt % based on the fully formulated detergent composition.

Thus the detergent compositions of the invention are generally prepared by firstly preparing the first, second and optional third granules and mixing them in a dry mixing process with any further dry-added detergent ingredients desired in the fully formulated detergent composition. Additional liquid ingredients such as surfactant and/or additional polymeric detergent ingredients can be sprayed on at any stage in the mixing for example onto a single component such as the first granule, or onto mixtures of detergent ingredients.

The detergent compositions of the invention will generally have a bulk density at least 300 g/l or at least 400 g/l and upt to 1000 g/l or 900 g/l or below (as measured by the method now described). The measurement method for the bulk density of the compositions mentioned herein can be measured by a simple technique which involves dispensing a quantity of the granular material into a container of known volume, measuring the weight of material and reporting the density as grams/litre. The method used herein allows the material to flow into the measuring container under gravity, and without pressure or other compaction in the measuring container. The density measurements should be run at room temperature. The granular material whose density is being measured should be at least 24 hours old and should be held at room temperature for 24 hours prior to testing. A relative humidity of 50% or less is convenient. Of course, any clumps in the material should be gently broken up prior to running the test. The sample of material is allowed to flow through a funnel mounted on a filling hopper and stand (#150; Seedburo Equipment Company, Chicago, Ill.) into an Ohaus cup of known volume and weight (#104; Seedburo). The top of the cup is positioned about 50 mm from the bottom of the funnel, and the cup is filled to overflowing. A spatula or other straight edge is then scraped over the top of the cup, without vibration or tapping, to level the material, thereby exactly and entirely filling the cup. The weight of material in the cup is then measured. Density can be reported as g/l. Two repeat runs are made and the bulk density is reported as an average of the three measurements. Relative error is about 0.4%.

The additional detergent ingredients which may be incorporated into the compositions of the invention are typically selected from the group consisting of detersive surfactants, builders, polymeric co-builders, bleach, chelants, enzymes, anti-redeposition polymers, soil-release polymers, polymeric soil-dispersing and/or soil-suspending agents, dye-transfer inhibitors, fabric-integrity agents, suds suppressors, fabric-softeners, flocculants, perfumes, whitening agents, photobleach and combinations thereof.

The precise nature of these additional components, and levels of incorporation thereof will depend on the physical form of the composition or component, and the precise nature of the washing operation for which it is to be used.

A highly preferred adjunct component is a surfactant. Preferably, the detergent composition comprises one or more surfactants. Typically, the detergent composition comprises (by weight of the composition) from 0% to 50%, preferably from 5% and more preferably from 10 or even 15 wt % to 40 wt %, or to 30%, or to 20% one or more surfactants. Preferred surfactants are anionic surfactants, non-ionic surfactants, cationic surfactants, zwitterionic surfactants, amphoteric surfactants, cationic surfactants and mixtures thereof.

A preferred additional detergent ingredient is a bleaching agent. Preferably, the detergent composition comprises one or more bleaching agents. Typically, the composition comprises (by weight of the composition) from 1% to 50% of one or more bleaching agent. Preferred bleaching agents are selected from the group consisting of sources of peroxide, sources of peracid, bleach boosters, bleach catalysts, photo-bleaches, and combinations thereof. Preferred sources of peroxide are selected from the group consisting of: perborate monohydrate, perborate tetra-hydrate, percarbonate, salts thereof, and combinations thereof. Preferred sources of peracid are selected from the group consisting of: bleach activator typically with a peroxide source such as perborate or percarbonate, preformed peracids, and combinations thereof. Preferred bleach activators are selected from the group consisting of: oxy-benzene-sulphonate bleach activators, lactam bleach activators, imide bleach activators, and combinations thereof. A preferred source of peracid is tetra-acetyl ethylene diamine (TAED) and peroxide source such as percarbonate. Preferred oxy-bonzene-sulphonate bleach activators are selected from the group consisting of: nonanoyl-oxy-benzene sulphonate, 6-nonamido-caproyl-oxy-benzene-sulphonate, salts thereof, and combinations thereof. Preferred lactam bleach activators are acyl-caprolactams and/or acyl-valerolactams. A preferred imide bleach activator is N-nonanoyl-N-methyl-acetamide.

Preferred preformed peracids are selected from the group consisting of N,N-pthaloyl-amino-peroxycaproic acid, nonyl-amido-peroxyadipic acid, salts thereof, and combinations thereof. Preferably, the STW-composition comprises one or more sources of peroxide and one or more sources of peracid. Preferred bleach catalysts comprise one or more transition metal ions. Other preferred bleaching agents are di-acyl peroxides. Preferred bleach boosters are selected from the group consisting of: zwitterionic imines, anionic imine polyions, quaternary oxaziridinium salts, and combinations thereof. Highly preferred bleach boosters are selected from the group consisting of: aryliminium zwitterions, aryliminium polyions, and combinations thereof. Suitable bleach boosters are described in U.S. Pat. No 360,568, U.S. Pat. No. 5,360,569 and U.S. Pat. No. 5,370,826.

A preferred optional detergent ingredient is an anti-redeposition agent. Preferably, the detergent composition comprises one or more anti-redeposition agent. Preferred anti-redeposition agents are cellulosic polymeric components, most preferably carboxymethyl celluloses.

A preferred additional detergent ingredient is a chelant. Preferably, the detergent composition comprises one or more chelants. Preferably, the detergent composition comprises (by weight of the composition) from 0.01% to 10% chelant. Preferred chelants are selected from the group consisting of: hydroxyethane-dimethylene-phosphonic acid, ethylene diamine tetra (methylene phosphonic) acid, diethylene triamine pentacetate, ethylene diamine tetraacetate, diethylene triamine penta (mhyl phosphonic) acid, ethylene diamine disuccinic acid, and combinations thereof.

A preferred additional detergent is a dye transfer inhibitor. Preferably, the detergent composition comprises one or more dye transfer inhibitors. Typically, dye transfer inhibitors are polymeric components that trap dye molecules and retain the dye molecules by suspending them in the wash liquor. Preferred dye transfer inhibitors are selected from the group consisting of: polyvinylpyrrolidones, polyvinylpyridine N-oxides, polyvinylpyrrolidone-polyvinylimidazole copolymers, and combinations thereof.

A preferred additional detergent ingredient is an enzyme. Preferably, the detergent composition comprises one or more enzymes. Preferred enzymes are selected from the group consisting of: amylases, arabinosidases, carbohydrases, cellulases, chondroitinases, cutinases, dextranases, esterases, β-glucanases, gluco-amylases, hyaluronidases, keratanases, laccases, ligninases, lipases, lipolygenases, malanases, mannanases, oxidases, pectinases, pentosanases, peroxidases, phenoloxidases, phospholipases, proteases, pullulanases, reductases, tannases, transferases, xylanases, xyloglucanases, and combinations thereof. Preferred enzymes are selected from the group consisting of: amylases, carbohydrases, cellulases, lipases, proteases, and combinations thereof.

A preferred additional detergent ingredient is a fabric integrity agent. Preferably, the detergent composition comprises one or more fabric integrity agents. Typically, fabric integrity agents are polymeric components that deposit on the fabric surface and prevent fabric damage during the laundering process. Preferred fabric integrity agents are hydrophobically modified celluloses. These hydrophobically modified celluloses reduce fabric abrasion, enhance fibre-fibre interactions and reduce dye loss from the fabric. A preferred hydrophobically modified cellulose is described in WO99/14245. Other preferred fabric integrity agents are polymeric components and/or oligomeric components that are obtainable, preferably obtained, by a process comprising the step of condensing imidazole and epichlorhydrin.

Other additional detergent ingredients are salts. Preferably, the detergent composition comprises one or more salts. The salts can act as alkalinity agents, buffers, builders, co-builders, encrustation inhibitors, fillers pH regulators, stability agents, and combinations thereof.

A preferred additional detergent ingredient is a soil release agent. Preferably, the detergent composition comprises one or more soil release agents. Typically, soil release agents are polymeric compounds that modify the fabric surface and prevent the redeposition of soil on the fabric. Preferred soil release agents are copolymers, preferably block copolymers, comprising one or more terephthalate unit. Preferred soil release agents are copolymers that are synthesised from dimethylterephthalate, 1,2-propyl glycol and methyl capped polyethyleneglycol. Other preferred soil release agents are anionically end capped polyesters.

A further additional detergent ingredient is a soil suspension agent. Preferably, the detergent composition comprises one or more soil suspension agents. Preferred soil suspension agents are polymeric polycarboxylates. Especially preferred are polymers derived from acrylic acid, polymers derived from maleic acid, and co-polymers derived from maleic acid and acrylic acid. In addition to their soil suspension properties, polymeric polycarboxylates are also useful co-builders for laundry detergents. Other preferred soil sulspension agents are alkoxylated polyalkylene imines. Especially preferred alkoxylated polyalkylene imines are ethoxylated polyethylene imines, ore ethoxylated-propoxylated polyethylene imine. Other preferred soil suspension agents are represented by the formula:
Bis((C₂H₅O)(C₂H₄O)ₙ)(CH3)—N⁺—CₓH₂ₓ—N⁺—(CH₃)-bis((C₂H₄O)ₙ(C₂H₅O)),
Wherein, n=from 10 to 50 and x=from 1 to 20. Optionally, the soil suspension agents represented by the above formula can be sulphated and/or sulphonated.
Softening System

The detergent compositions of the invention may comprise softening agents from softening through the wash such as clay optionally also with flocculant and enzymes.

Further more specific description of suitable detergent components can be found in WO97/11151.

### EXAMPLES

The following are examples of the invention.

### Example A

TABLE 1

| | Example 1 |
|---|---|
| Raw Material | % slurry |
| Phosphonate Chelant | 1.1 |
| MgSO4 | 3.1 |
| Na₂SO₄ | — |
| Maleic acid/acrylic | 5.2 |
| acid copolymer (salt | |
| form) Sokalan CP5 | |
| (tradename from | |
| BASF) | |
| C₁₂₋₁₈ alkyl benzene | 6.9 |
| sulphonate (Na salt) | |
| LAS | |
| STTP | 22.0 |
| Cationic Surfactant | 1.7 |
| Miscellaneous | 15.0 |
| Water | 40 |
| Total parts | 100.0 |

A homogeneous aqueous slurry of the components shown above was made up with the moisture content shown. The slurry was heated to 80° C. and fed under high pressure, (6,000-7,000 kPa), into a conventional counter-current spray drying tower with an air inlet temperature of 300-310° C. The atomised slurry was dried to produce a granular solid which was then cooled and sieved to remove oversize (>2 mm). Fine (<0.15 mm) material was elutriated with the exhaust air in the spray-drying tower and collected in a containment system. The finished granules had a moisture content of about 10% by weight, a bulk density of 383 g/l and a particle size distribution such that 56.4% by weight of the granules were between 150-710 microns in size. The particles formed were free-flowing. The spray-dried powder had a composition as shown in table 2 below.

TABLE 2

| | % Spray dried |
|---|---|
| | granule |
| Raw Material | Example 1 |
| Phosphonate Chelant | 1.6 |
| MgSO4 | 4.74 |
| Na₂SO₄ | — |
| MA/AA (Sokalan | 7.9 |
| CP5) | |
| Silicate | 18.9 |
| LAS | 15.8 |
| STTP | 32.9 |
| Cationic Surfactant | 2.6 |
| Miscellaneous | 0.3 |
| Water | 10.3 |
| Total Parts | 100 |

These particles of example A (A(1) or A(2)) are incorporated into the following solid laundry detergent compositions according to the invention (Table 3). Amounts given below are percentages by weight of the fully formulated detergent composition.

TABLE 3

| Ingredient | A | B | C |
|---|---|---|---|
| Example A particles | 43 | 55 | 50 |
| Agglomerates | 10 | 5 | 10 |
| LAS | 3.5 | 1.8 | 3.5 |
| Sodium carbonate | 1.3 | 0.7 | 1.3 |
| Zeolite (anhydrous) | 3.7 | 1.9 | 3.7 |
| Mics/water | 1.5 | 0.6 | 1.5 |
| C12-14N⁺(CH₃)₂(C₂H₄OH), | 0.6 | 1 | |
| C₁₂₋₁₈ linear alkyl | 4 | 3.3 | 3 |
| ethoxylate condensed | | | |
| with an average of 3-9 | | | |
| moles of ethylene oxide | | | |
| per mole of alkyl alcohol | | | |
| Citric acid | 2 | 1 | |
| Sodium tripolyphosphate | 5 | 5 | 7 |
| (anhydrous weight | | | |
| given) | | | |
| Sodium carboxymethyl | 0.2 | 0.2 | |
| cellulose | | | |
| Copolymer of | 1.2 | 0.5 | 1 |
| maleic/acrylic acid, | | | |
| having a weight average | | | |
| molecular weight of | | | |
| from 50,000 to 90,000, | | | |
| wherein the ratio of | | | |
| maleic to acrylic acid is | | | |
| from 1:3 to 1:4 (Sokalan | | | |
| CP5 from BASF) | | | |
| Proteolytic enzyme | 0.2 | 0.2 | 0.5 |
| having an enzyme | | | |
| activity of from 15 m/g | | | |
| to 70 mg/g | | | |
| Amyolitic enzyme | 0.2 | 0.2 | 0.3 |
| having an enzyme | | | |
| activity of from 25 mg/g | | | |
| to 50 mg/g | | | |
| Lipolyic enzyme having | | 0.2 | 0.1 |
| an enzyme activity of 5 mg/g | | | |
| to 25 mg/g | | | |
| Anhydrous sodium | | | 7 |
| perborate monohydrate | | | |
| Sodium percarbonate | 17 | 6 | |
| Magnesium sulphate | | | |
| Nonanoyl oxybenzene | | | |
| sulfonate | | | |
| TAED | 3 | 2 | 2 |
| Brightener | 0.1 | 0.1 | 0.2 |
| Sodium carbonate | 10 | 5 | 5 |
| Sodium sulfate | | 5 | 3 |
| Zeolite A | 3 | 2 | |
| Crystalline layered | 3 | 5 | |
| silicate | | | |
| Photobleach | 0.002 | | |
| Polyethylene oxide | 2 | 1 | |
| having a weight average | | | |
| molecular weight from | | | |
| 100 to 10,000 | | | |
| Perume spray-on | 0.2 | 0.5 | 0.25 |
| Starch encapsulated | 0.4 | | |
| perfume | | | |
| Silicone based suds | 0.05 | 0.05 | 0.02 |
| suppressor | | | |
| Miscellaneous and | To 100% | To 100% | To 100% |
| moisture | | | |

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A detergent composition comprising at least two granular components: (1) a first granule comprising:
(1a) at least 6 wt % (based on the first granule) of a polycarboxylate-polymer or mixtures thereof;
(1b) at least 25 wt % phosphate salt; and
(1c) at least 8 wt % surfactant; and
(1d) optional additional detergent ingredients to 100 wt %; and
(2) a second granule comprising:
(2a) at least 75 wt % (based on the second granule) of a phosphate salt; and
(2b) optional additional detergent ingredients to 100 wt %.

2. A detergent composition according to claim 1 wherein said first granule comprises from 10 to 30 wt % (based on the first granule) of a polycarboxylate polymer.

3. A detergent composition according to claim 1 wherein said first granule is a spray-dried granule.

4. A detergent composition according to claim 1 wherein said second granule comprises a particle of sodium tripolyphosphate.

5. A detergent composition according to claim 1 wherein the bulk density of said first granule is from 200 to 500 g/l.

6. A detergent composition according to claim 1 wherein the bulk density of said second granule is from 650 to 1000 g/l.

7. A detergent composition according to claim 1 comprising from 35 to 60 wt % of said first granule, and from 5 to 12% by weight of said second granule, based on the weight of the fully formulated detergent composition.

8. A detergent composition according to claim 1 additionally comprising a third granule, said third granule comprising surfactant in an amount of from 35 to 60 wt % based on the weight of said third granule.

9. A detergent composition according to claim 1 comprising less than 5 wt % sodium carbonate and less than 2 wt % sodium sulphate.

10. A method for making a detergent composition according to claim 1 comprising a first dry mixing step wherein first granules, second granules, optional third granules and any optional additional detergent ingredients in solid particulate form are mixed to form a dry intermediate and an optional second step wherein surfactant and/or polymer in liquid form are sprayed onto the dry intermediate.
